(19) United States
(12) Patent Application Publication
(10) Pub. No.: US 2007/0006701 A1
(43) Pub. Date: Jan. 11, 2007

(54) Feed mechanism for slicing machine

(76) Inventor: Donald G. Lunghi, Hillsborough, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/175,577

(22) Filed: Jul. 5, 2005

(51) Int. Cl. B26D 5/20

(52) U.S. Cl. 83/282

(57) ABSTRACT

A stabilizer for stabilizing the butt end of a food product log being sliced into slices. The stabilizer is positioned between a conveyor conveying food product logs into a slicer and the slicer. Opposing side portions carrying stabilizing pinchers are moved out of engagement of a food product log being conveyed by the conveyor and into engagement upon release by the conveyor of the log being fed into the slicer.

### FIELD OF THE INVENTION

This invention relates to food packaging and more particularly to the successive feeding of food logs through a slicing machine.

### BACKGROUND OF THE INVENTION

It is common to package trays of presliced foods such as cheese and meats including, but not limited to, bologna, ham, beef, chicken, turkey and the like. The product is prepared first as elongate logs which are then sliced into desired thicknesses, e.g. for sandwiches, then in stacked or shingled arrangement, which arrangements are placed in trays and then wrapped and displayed in grocery stores and the like. Alternatively, certain food outlets will sell a prepared sandwich and one or more slices may be placed on a bun which is then wrapped and displayed, e.g. in convenience stores.

Typically, logs are sliced and placed on one end of a first conveyor and the conveyor delivers the slices to a food product applicator. A second conveyor moves cross way to the first conveyor at the same end and the applicator precisely transfers the individual stack or shingled slices onto or into buns and trays being conveyed by the second conveyor.

A problem of the slicing operation is addressed by the first conveyor. The food logs (e.g., of 3′ to 6′ lengths) are fed into the slicer in rapid succession. Nevertheless, there is a delay in the slicing operation as one log is completely sliced, and the following log is fed into the slicer. A portion of the trailing end of the log is not straight, i.e. the butt end and the primary log length do not meet at squared corners but is rounded in some fashion. This causes feeding problems, e.g. for the last inch or so of the log end and the rounded end or a portion thereof is either removed and discarded before slicing or a special feed mechanism takes over for that last end portion. In either event, the slicing operation is momentarily interrupted or at least slowed. An object of the present invention accordingly is to eliminate or alleviate this interruption of food log feeding.

### BRIEF DESCRIPTION OF THE INVENTION

A typical log or log feeding system is comprised of a pair of elongate conveyor loops such as conveyor chains or belts that grip opposed sides of the food log and forces the log on a desired pathway and into a slicer. Such conveyers run up close to the blade of the slicer and then curve away from the log for the return run to the log entry position. The curved path results in the release of the log, e.g., during the last half inch prior to slicing. Thus, as the back or butt end approaches the slicer, at least in the last half inch there is no gripping/holding action. Such loss of gripping at the rear or butt end is further aggravated by the typical shape of the log at the rear end, i.e., it is typically slightly rounded. Whereas a following log's leading end will be pushing against the prior log's butt end, that butt end is free to twist and turn and whatever slices result at the butt end are likely not acceptable.

The present invention resolves this butt end stabilizing problem with circumferentially spaced pinchers that laterally advance into the butt end on demand. The pinchers are configured like the tips of knives with a leading sharp edge and blunt trailing edge, and collectively penetrate into the food log to stabilize its advancement into the slicer. The pinchers do not advance with the log toward the slicer. The log simply pushes through the stabilizing pinchers resulting in a like number of slits at the periphery of the slices that are cut from this butt end. These slits are substantially nonvisible or practically so and are considered acceptable for the otherwise neatly packaged food product as deposited and wrapped.

The invention will be more fully appreciated upon reference to the following detailed description having reference to the accompanying drawings.

### BRIEF DESCRIPTION OF THE DRAWINGS

FIG. 1 schematically illustrates a typical log feeding process;

FIG. 2 illustrates the process of FIG. 1 transitioning from one food log to a following log;

FIGS. 3 and 3A illustrate the introduction of a butt end stabilizer to the system of FIGS. 1 and 2;

FIG. 4 illustrates the butt end stabilizer of FIG. 3 in its retracted position;

FIG. 5 illustrates a slice off the butt end of a log having been stabilized as illustrated in FIGS. 3 and 3A; and

FIGS. 6 and 7 illustrate in perspective view the stabilizer in operation as schematically portrayed in FIGS. 3 and 4, respectively.

### DETAILED DESCRIPTION OF THE PREFERRED EMBODIMENT

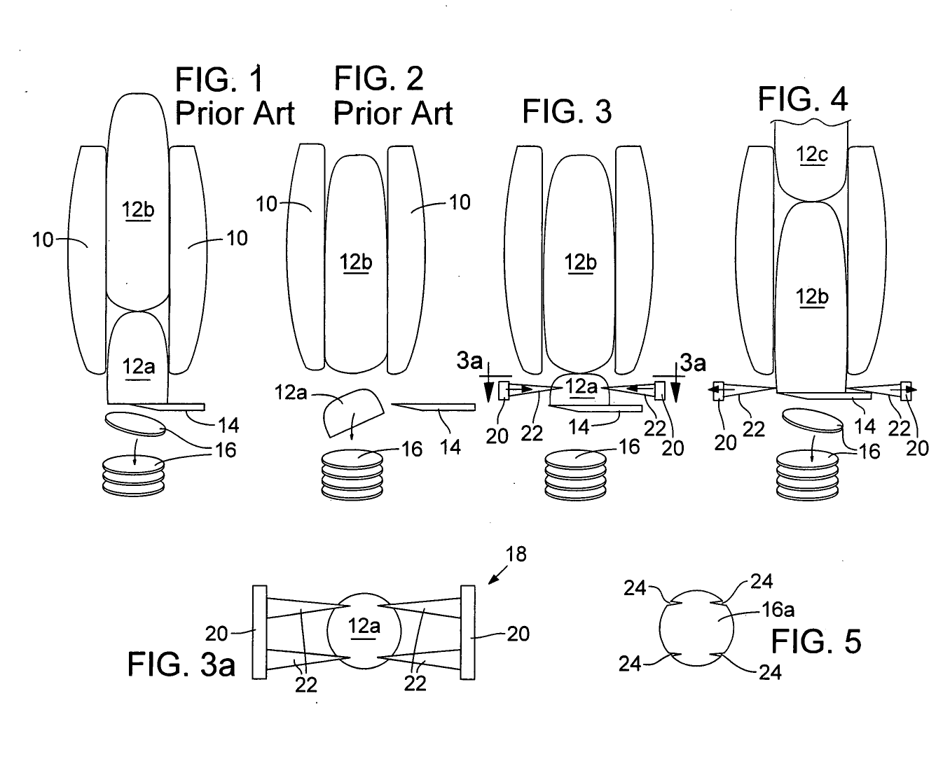

Reference is now made to FIGS. 1 and 2 illustrating a prior art system and the problem associated with that system. A log conveyor includes a pair of belt conveyors 10 that press opposing sides of food logs 12a, 12b to sequentially feed the log downwardly to the location of a slicer 14 that slices off slices 16. In FIG. 1, the leading log 12a is firmly gripped by the conveyor 10 to incrementally feed log 12a into the path of the knife 14 for slicing off slices 16.

FIG. 2 illustrates log 12a having been sliced away by the slicer 14 all but the butt end portion of log 12a. It will be observed that log 12a continues to be fed into the slicer by reason of the pushing action of log 12b and not by conveyor 10. It will be further observed that butt end 12a is skewed from its normal orientation as is prevalent following release of the log from the conveyor 10.

It will be appreciated that the slicing action of slicer 14 when slicing the non stabilized butt end portion of 12a will now produce nonsymmetrical slices substantially different from the slices sliced from the stabilized log (FIG. 1) and as such are undesirable.

Reference is now made to FIGS. 3, 3A, and FIG. 4. As shown in FIGS. 3 and 3A, a butt end stabilizer 18 includes two side portions, each including holding bars 20 with each carrying a plurality of holding pinchers 22. The bars 20 are moveable between engagement as shown in FIG. 3 and retraction as shown in FIG. 4. It will be appreciated that the system is automated to provide engagement as in FIG. 3 upon or just prior to the release of conveyor 10 from a log 12a being fed into the slicer 14.

In a preferred embodiment, the butt end stabilizer 18 is provided only with lateral in and out movement as represented by the arrows in FIGS. 3 and 4. As will be appreciated, following engagement, i.e., penetration of pinchers 22 into the food log as shown in FIG. 3A, the further incremental movement of the butt end of 3A (forced downward by following log 12b) will result in slicing of the food log as the butt end of 12a is forced into position relative to slicer 14.

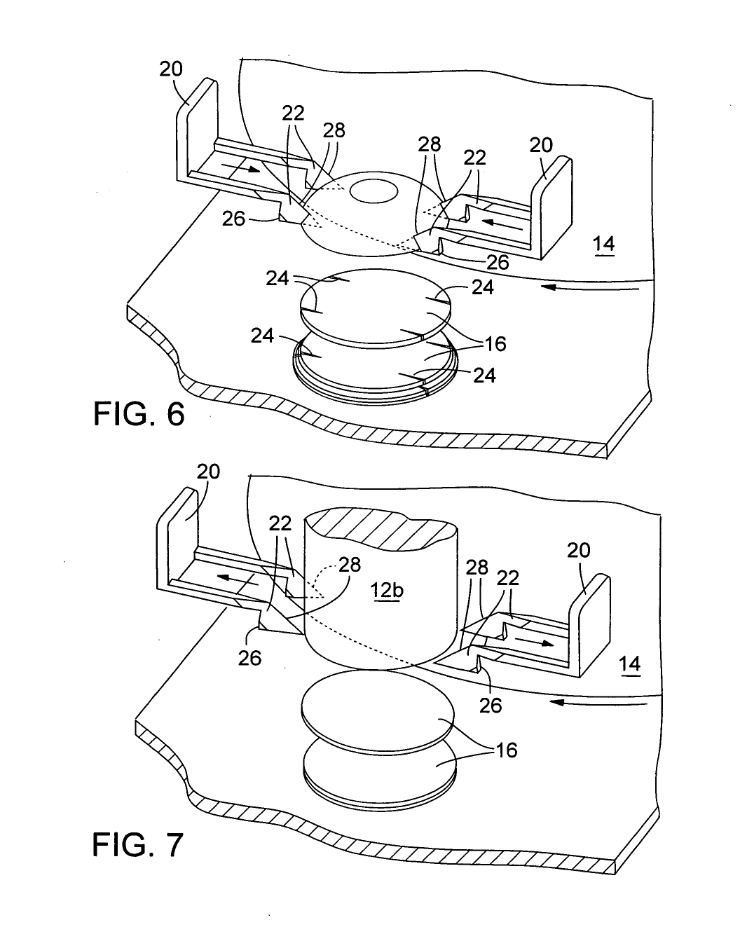

The butt end of log 12a will nevertheless be stabilized. The configuration of the holding pinchers 18, as will be noted from FIGS. 6 and 7, is that of a blade edge 28 facing angularly upwardly, i.e., counter to the log movement. Thus, the pinchers slide easily through the food log and due to the pincher becoming flared downwardly and outwardly, as noted at the following lower end 26, there is a reduced resistance in the feeding direction and greater resistance in the lateral direction. The effect is to first create a slit in the food log that is then forced to open, thereby urging the food log to a centered position between the holding bars 20 of stabilizer 18 and thus in a straight line toward the slicer 14. As the exposed leading end (of the butt end of log 12a) passes through the stabilizer and past holding pinchers 18, the opened slits of the log close and the resultant slice is a symmetrical and acceptable food product slice with slightly visible slits 24 as seen in FIGS. 5 and 7.

The above disclosure is that of a preferred embodiment and those skilled in the art will become aware of numerous variations and improvements without departing from the invention. The claims herein are accordingly intended to broadly encompass the invention, including such variations and improvements and accordingly the terms as used herein are to be given a broad interpretation commensurate with the teachings of this disclosure.

What is claimed is:

1. A food log feeder comprising:
a movable slicing blade for slicing slices from food product logs;
a food product conveyor conveying food product logs into position for incremental slicing of slices from the food product logs;
said conveyor providing sequential feeding of the logs whereby a leading log is reduced to a butt end that requires forced feeding by a subsequent log; and
a stabilizer positioned immediately preceding the slicer and having opposed side portions at opposed sides of the butt end location, said side portions including stabilizing pinchers that are movable into and out of engagement with the sides of such butt end, and when in engagement providing stabilization of said butt end as fed by a succeeding log into the slicer.

2. A log feeder as defined in claim 1 wherein the stabilizer pinchers have cutting edges facing the direction of food product log feeding.

3. A log feeder as defined in claim 2 wherein the stabilizer pinchers are uniformly flared rearwardly of said cutting edges to urge centering of the butt end for desired cutting orientation.

4. A log feeder as defined in claim 1 wherein the pinchers are mounted on movable side carriers that move the pinchers into engagement with the butt end portion upon release by the conveyor of the butt end portion of a food product log being sliced.
